(19) United States
(12) Patent Application Publication
(10) Pub. No.: US 2006/0249102 A1
(43) Pub. Date: Nov. 9, 2006

(54) Devices, systems and methods for controlling introduction of additives into an internal combustion engine

(75) Inventors: Glen A. Morgan, Newcastle, WA (US); Eugene Overly, Edmonds, WA (US); Thomas M. Wood, Redmond, WA (US); Wayne Rowberry, Redmond, WA (US); Dean Isemonger, Redmond, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: S.I.S. Power, Inc, Woodinville, WA (US)

(21) Appl. No.: 11/267,923

(22) Filed: Nov. 4, 2005

Related U.S. Application Data
(60) Provisional application No. 60/625,362, filed on Nov. 4, 2004.

(51) Int. Cl. F02M 25/025

(52) U.S. Cl. 123/25 J; 123/25 L; 123/25 K; 123/25 M

(57) ABSTRACT

A water injection control system includes a control unit adapted to receive one or more of a plurality of sensor signals from sensors provided as standard equipment in a vehicle, and to provide one or more control signals configured to control the operation of a water injection system associated with an engine of the vehicle. The received sensor signals may include signals from sensors such as an O₂ sensor, an engine coolant temperature sensor, a mass air flow sensor, a manifold absolute pressure sensor, a crankshaft position sensor, a vehicle speed sensor, an intake air temperature sensor, and a throttle position sensor. The control signals provided by the controller may include signals for controlling functions such as water injector pulse rate and pulse width, water pump operation, water heater power, dashboard indicators, and PCU O₂ sensor input.

### BACKGROUND OF THE INVENTION

1. Field of the Invention

This invention relates to internal combustion engines, and in particular, to devices, systems and methods for introducing water into the combustion chamber prior to or during ignition.

2. Description of the Related Art

The subject system utilizes a combination of well documented principles of operation. With respect to the combustion process in internal combustion engines, certain remarks will be made herebelow about the way a hydrocarbon fuel burns in an internal combustion engine, as well as the effect the fuel/air ratio has on the three main atmospheric contaminants discharged by such engine. These are limited by federal law and include CO (Carbon Monoxide), HC (unburnt hydrocarbons) and NOX (oxides of nitrogen).

For various reasons, a “chemically correct” mixture of fuel and air does not always get the best results by way of limiting contaminating exhaust emissions. Thus, ideally, for maximum power, the fuel/air mixture should be relatively richer, having a greater proportion of fuel. On the other hand, the fuel/air mixture should be leaner, utilizing less fuel than “chemically correct”, for the best economy.

Unfortunately, most of the steps that can be taken to reduce the amounts of CO and HC also tend to increase the NOX emission, with some loss in economy. For example, running at moderately lean mixtures, that is, with some excess air, promotes complete combustion. This minimizes the amount of CO and HC developed, but it also increases the combustion temperature to the point that the nitrogen in the air becomes involved in the reaction, causing highly poisonous oxides of nitrogen to be generated.

Since early 1971, the automobile manufacturers of the United States have been required by law to reduce exhaust emissions, improve fuel economy, and to increase performance in internal combustion engines. However, in order to accomplish these desired results, modification of the basic combustion process (as an alternative means for producing the three desired results) has received less attention than the addition of costly exhaust treatment devices such as thermal and/or catalytic oxidation of hydrocarbon and carbon monoxide in the engine exhaust system. Nitrogen oxide generation has-been reduced to some extent through a combination of retarded spark ignition timing and exhaust gas recirculation, both factors serving to diminish the severity of the combustion process.

With respect to water injection, tests were carried out by a Mr. Benki, in Hungary, before 1900 and thereafter by numerous researchers both in this country and abroad. These tests showed that the use of an internal coolant (i.e., a coolant introduced into the combustion chamber) such as water had the power to prevent pre-ignition and detonation. In the early days, detonation, especially, was a severe problem because of the low octane value of the fuel available and the trend toward increasing the compression ratio of engines to obtain higher efficiency.

In 1913, a professor B. Hopkinson, in England, carried out extensive tests with water as an internal coolant for horizontal gas engines. So successful was the method that Professor Hopkinson used, that he designed engines without water jackets, using internal cooling only. Oil engines designed in the middle 1920's, for tractor work, with hot bulb ignition, were commonly fitted with water injection equipment to prevent detonation.

Developments in super charged aircraft engines in the time interval from World War I to the beginning of World War II brought water injection back to life. During World War II, water and water/alcohol injection were used to great success, particularly at take-off and during maximum flight speed.

After World War II water and water/alcohol injection experience was gained from such use as internal coolants for truck engines and tractor engines. During the period from 1944 to 1959 water injection was particularly researched by several universities in this country, England, Canada and Australia. Dozens of papers have been written on the subject.

With respect to water vapor, as opposed to water injection, per se, it was not until after World War II, when certain German technical documents were translated into English, that it was learned that two researchers, while conducting combustion gas experiments had found, for example, that the combustion velocity of carbon monoxide and air mixtures increases from 6.3 inches/second for a dry mixture to about 21.6 inches/second for mixtures containing 9.4 percent water vapor. These investigators were Ubbelohde and Dommer, reporting in Gas U. Wasserfach 1914. Other researchers in Germany verified these facts and carried tests further in which they found and reported that the combustion velocity of carbon monoxide was not only accelerated by water vapor but also by hydrogen, as well as organic compounds containing hydrogen. This was interpreted as a sign that OH radicals and perhaps H-atoms participated in the reaction. Their presence would in themselves accelerate the reaction, as well as also increase the combustion velocity indirectly by diffusing very rapidly. (K. Bunte and associates in Gas U. Wasserfach 1932)

Other research papers substantiate the influence water vapor has on turbulence, flame propagation and flame velocity.

B. W. Bradford reported in J. Chem Society 1933, P.73 that catalytic combustion of CO on quartz surfaces is inhibited by liquid water, whereas the gas reaction is greatly accelerated by water vapor.

From the above background, it became apparent to the applicant that water vapor, when properly introduced and mixed in fuel/air mixtures, for combustion, in internal combustion engines would be the ideal internal coolant. This would be not only for increased engine performance, but also for fuel economy and limiting the generation of and discharge of the three main atmospheric contaminants. Specifically, carbon monoxide, unburnt hydrocarbons and oxides of nitrogen.

### BRIEF SUMMARY OF THE INVENTION

According to an embodiment of the invention, a water injection control system is provided, including a control unit configured to receive one or more of a plurality of sensor signals from sensors provided as standard equipment in a vehicle, and to provide one or more control signals configured to control the operation of a water injection system associated with an engine of the vehicle. The received sensor signals may include signals from sensors such as an O₂ sensor, an engine coolant temperature sensor, a mass air flow sensor, a manifold absolute pressure sensor, a crankshaft position sensor, a vehicle speed sensor, an intake air temperature sensor, and a throttle position sensor.

The control signals provided by the controller may include signals for controlling functions such as water injector pulse rate and pulse width, water pump operation, water heater power, dashboard indicators, and PCU O₂ sensor input.

According to another embodiment of the invention, the control unit is further configured to receive an additional signal from each of one or more additional sensors associated with function of the injection system. Such additional sensors may include a water pressure sensor, a water temperature sensor, a water level sensor, a system power sensor, a manifold water residue sensor, and an intake air humidity sensor.

One of ordinary skill in the art, having reviewed this entire disclosure and the corresponding figures, will appreciate these embodiments and variations as well as other embodiments and variations that can be made to the embodiments shown and described below without deviating from the spirit of the present invention.

### BRIEF DESCRIPTION OF THE SEVERAL VIEWS OF THE DRAWINGS

FIG. 1 is a schematic illustration of a system for introducing water into an internal combustion engine.

FIG. 2 is a schematic illustration of a water intake sub-system from a system for introducing water into an internal combustion engine.

FIG. 3 is a side elevation view schematically illustrating an injector and heater sub-assembly from a system for introducing water into an internal combustion engine, incorporated into a portion of an intake system for an internal combustion engine.

FIG. 4 is a cutaway plan view schematically illustrating the injector and heater sub-assembly and intake system of FIG. 3.

FIG. 5 is an elevational cross-section of the injector and heater sub-assembly of FIG. 3, shown along Section 5-5.

FIG. 6 is a plan cross-section of the injector and heater sub-assembly of FIG. 3, shown along Section 6-6.

FIG. 7 is a schematic diagram of a control system for a system for introducing water into an internal combustion engine, according to an embodiment of the present invention.

FIG. 8 is a schematic diagram of an interface module for a system for introducing water into an internal combustion engine, according to an embodiment of the present invention.

FIG. 9 is a cutaway plan view schematically illustrating an intake system incorporating injector and heater sub-components, according to an alternate embodiment of the present invention.

FIG. 10 is a cutaway plan view schematically illustrating an intake system and a plurality of injector and heater sub-assemblies, according to another alternate embodiment of the present invention.

FIG. 11 illustrates an injection control system according to an additional embodiment of the invention.

FIG. 12 shows a flow chart depicting the operation of the water injection control system of FIG. 11.

FIG. 13 is a chart that illustrates a decision matrix for generating a control signal output.

### DETAILED DESCRIPTION OF THE INVENTION

The present detailed description is directed toward devices, systems and methods for controlling the introduction of water into the combustion chamber of an internal combustion engine. Many specific details are provided and illustrated to help explain the construction and operation of the particular embodiments of the invention. The invention could take on other embodiments, and one of ordinary skill in the art, having reviewed the present disclosure and corresponding drawings in their entireties, would readily appreciate modifications that could be made to the illustrated embodiments without deviating from the spirit of the invention. Thus the invention is not to be limited to the specific embodiments illustrated in the drawings and described in connection therewith.

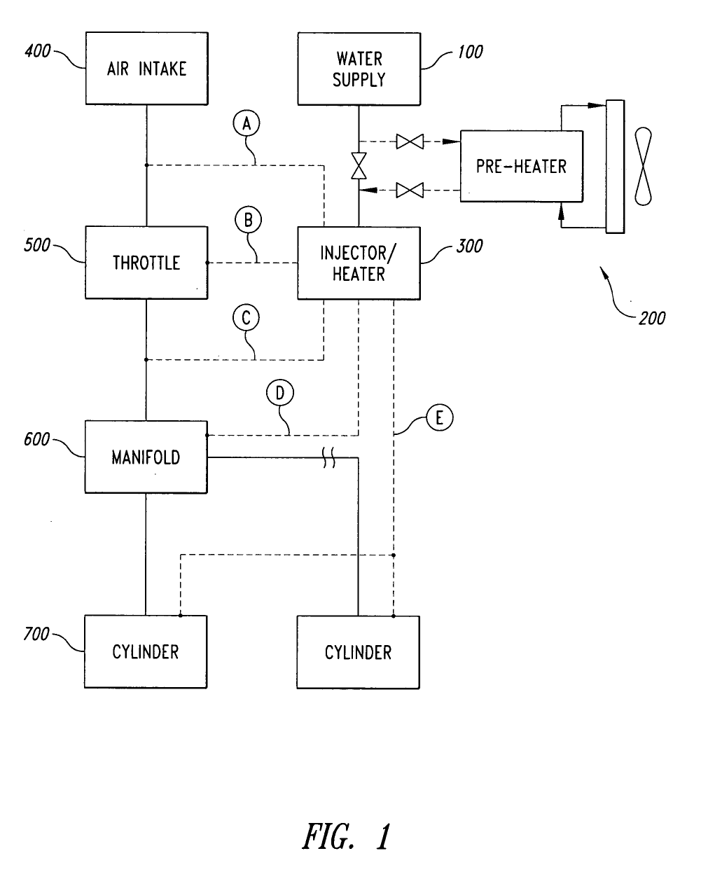

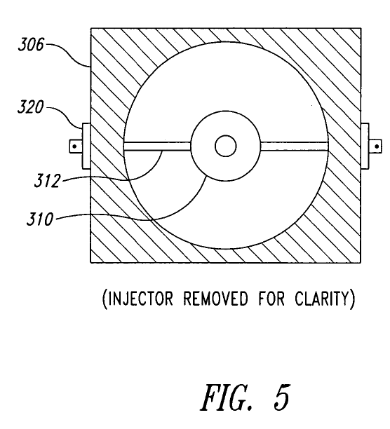

FIGS. 1-8 and the accompanying descriptive text collectively illustrate only some of the various systems for introducing water into the air-fuel mixture burned in the combustion chamber of an internal combustion engine, such as may be employed in conjunction with an embodiment of the invention. A more extensive discussion of the systems described herein may be found in U.S. patent application Ser. No. 10/907,1164, which is incorporated herein by reference, in its entirety.

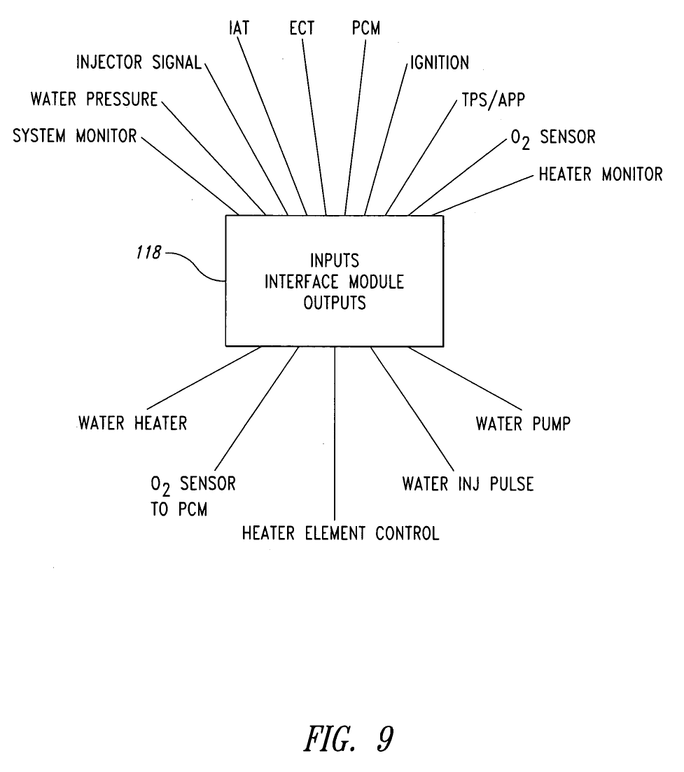

Detailed discussion of the inventive control method and system begins with reference to FIG. 9.

Retrofit Systems for Existing Engines

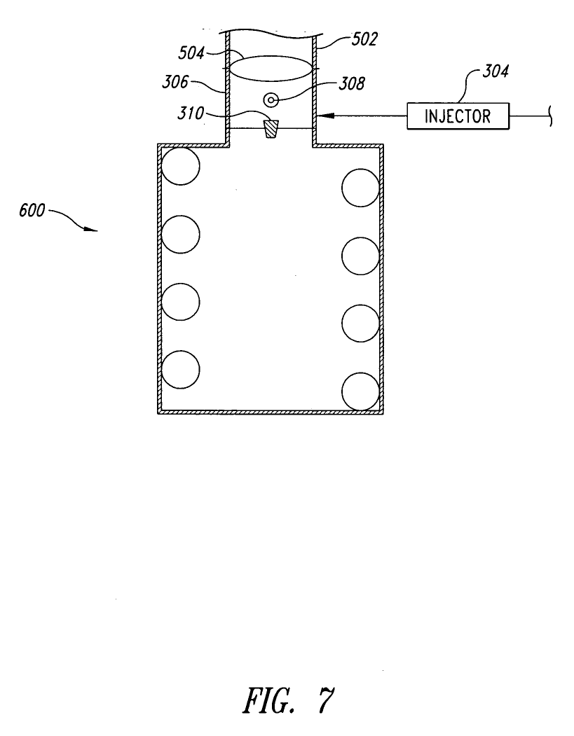

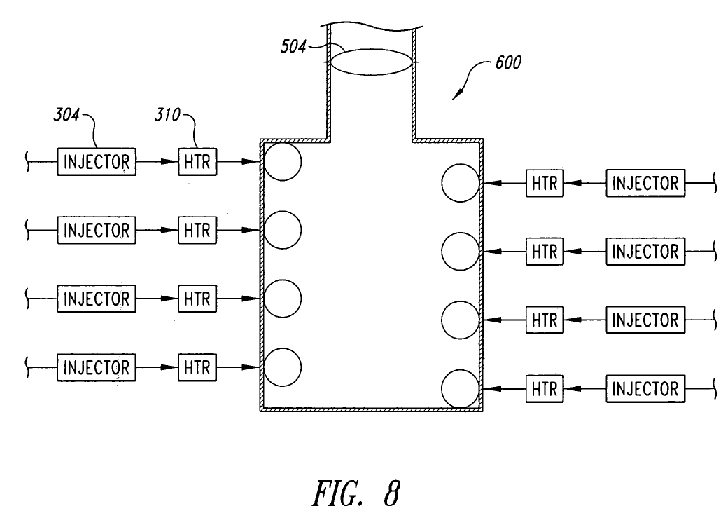

FIGS. 1-6 illustrate one particular example, in which an internal combustion engine is retrofitted to incorporate a system for introducing water into the combustion chamber. Many of the structures, controls and features of the present invention can be fully appreciated following a detailed review of this particular example. However, many of those structures, features and controls, as well as their associated advantages, are applicable to other systems. Accordingly, two additional systems are described with reference to FIGS. 7 and 8 with an understanding that the systems described with reference to FIGS. 1-8 are exemplary, only, and that the control methods and systems provided, according to various embodiments of the invention, may be implemented in cooperation with many water introduction systems not specifically described herein.

FIG. 1 generally illustrates the major sub-systems that would typically be incorporated into a water introduction system, and/or those components that may be modified to retrofit a standard engine to support the system. As Identified therein by reference numbers, these sub-systems include: a water supply 100, an optional pre-heater 200, an injector/heater 300, an air intake 400, a throttle 500, an intake manifold 600 and a combustion cylinder 700.

Each of these sub-systems will be illustrated and/or discussed further later in this disclosure, but in general, the water supply 100 retains and supplies process water to the system at a controlled pressure; the optional pre-heater 200 is selectively operated to heat the process water to a desired initial temperature, typically but not exclusively in environments having an extremely low ambient temperature; the injector/heater 300 introduces water into the engine at a controlled flow rate, volume and/or pulse frequency, as determined by a variety of performance criteria, and converts the water to steam as it is introduced into the engine; the air intake 400 introduces ambient air into the engine; the throttle 500 controls the amount of air and/or steam-air mixture delivered to the engine at any particular time; the intake manifold 600 routs the air and/or steam-air mixture to each combustion cylinder; and the cylinder 700 retains the steam-air-fuel mixture during combustion.

As illustrated by broken lines in FIG. 1, the steam generated by the injector/heater sub-system 300 can be introduced into the engine at several locations: (A) between the air intake 400 and the throttle 500; (B) into the housing of the throttle 500; (C) between the throttle 500 and the intake manifold 600; (D) into the intake manifold 600, either centrally or at a location dedicated to each intake port; and/or (E) directly into each cylinder 700. An individual of skill in the art will appreciate the modifications that would be necessary to convert from one option to the next, and the effect each option may have on ease of manufacture and repair, cost, efficiency, performance, and other common engine-design criteria.

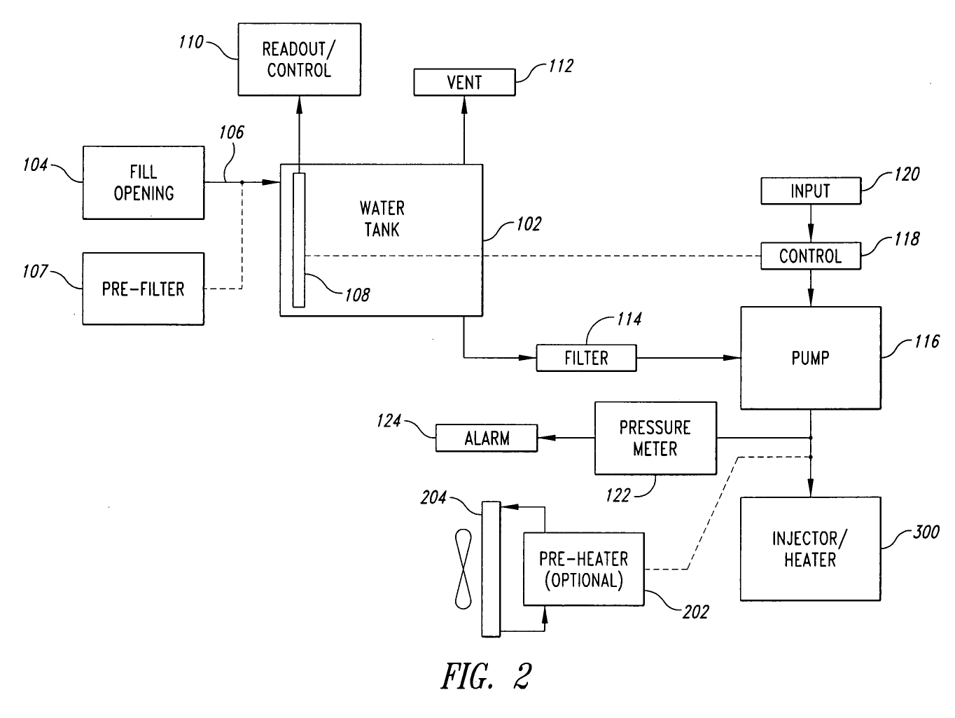

FIG. 2 illustrates in more detail one possible design of the water supply 100 and pre-heater 200 sub-systems. Water is retained in a water tank 102, which can be filled by pouring water into a fill opening 104 attached to the water tank by a fill neck 106. The water tank 102 is sized based on the size of the engine and the size of the fuel tank, with the goal being that the water tank need not be filled more frequently than the fuel tank. A pre filter 107 may be used to filter water before it enters the water tank 102.

A level sensor 108 in the watertank 102 sends signals to a display 110, which displays the water level to the driver. The level sensor also sends a signal to a main controller 118, which as discussed below is used in this particular embodiment to control many of the elements of the system. A signal from the level sensor 108 indicating an empty water tank 102 results in a signal from the controller 118 to other elements in the system to shut off the injector/heater sub-system 300 and other elements of the system (such as the pump, discussed below).

A vent 112 maintains pressure in the water tank 102 at atmospheric pressure, or can be configured to prevent the pressure in the water tank from exceeding a pre-selected pressure before the vent bleeds off air.

Water exits from the bottom of the water tank 102 and proceeds to a filter 114, which removes sediment and other impurities. From the filter 114, the water travels to a pump 116, which pressurizes the water to a desired pressure to optimize performance. The controller 118 receives data from various inputs 120, and adjusts the operation of the pump 116 to maintain optimal water pressure in the system. A pressure meter 122 reads the water pressure, and can display the pressure, feed it back to the controller 118 or another part of the system, and can trigger an alarm 124 should the pressure drop to an unacceptable level. From the pump 116, the pressurized water flows toward the injector/heater 300. In some systems, the pressurized water first flows to the pre-heater 200.

The illustrated pre-heater 200 incorporates a tube-in-tube heat exchanger 202 in which coolant from the radiator 204 flows through the outer tube and pressurized water from the pump 116 flows through the inner tube. As the coolant heats up, the heated coolant transfers heat to the water and the heated water returns to the system, flowing next toward the injector/heater 300.

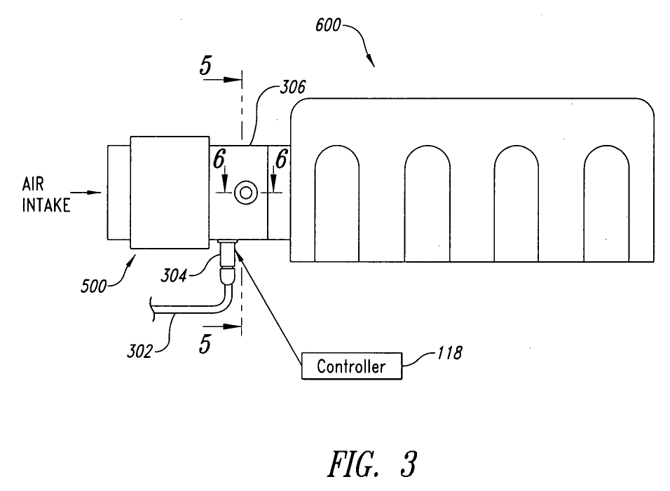

FIGS. 3-6 best illustrate the injector/heater 300 of this particular system. As best illustrated in FIG. 3, a tube 302 routes the water from the pump 116 or the heat exchanger 202, depending on the particular system, to a solenoid valve 304. The solenoid valve 304 is mounted to the air duct 306 between the throttle 500 and the intake manifold 600. The durations for which the solenoid valve 304 remains open and closed, and the frequency of the toggling of the solenoid valve (based, for example on the pulse width and frequency of the incoming signal)—both of which affect the amount of water injected into the system—are controlled by the controller 118.

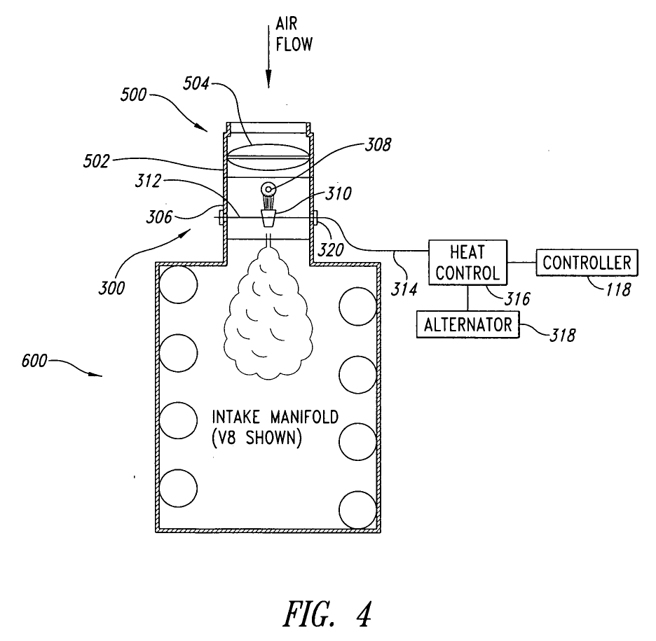

As best illustrated in FIG. 4, the solenoid valve 304 outside the air duct 306 is coupled to a nozzle 308 terminating inside the air duct. The illustrated nozzle 308 is centrally located in the air duct 306 (widthwise as illustrated in FIG. 4) to align with a heating element 310 also centrally located in the air duct. The nozzle 308 is located upstream with respect to the heater element 310, such that water injected into the air duct is carried with the air from the throttle 500 into the heating element.

The nozzle 308 is configured to dispense water in a spray pattern, to disperse the water in a manner conducive to converting the water to steam as the water passes the heating element 310.

As illustrated in FIGS. 4-6, the heating element 310 is mounted in the air duct 306 by a pair of wire mounts 312, which suspend the heating element while affecting the flow of air as little as possible. In one example, the heating element 310 incorporates a pair of glow plugs like those typically used in a standard diesel engine, and used in this application to generate heat for water vaporization.

One or both of the wire mounts 312 extends to the heating element 310 along with an electrical connector 314 that is coupled at one end to the heating element and at an opposing end to a heater control 316. The heater control 316 adjustably routes electricity from the alternator 318 to the heating element 310, based on control signals sent to the heater control from the controller 118. The wire mounts 312 and electrical connector 314 are mounted to the air duct 306 with a pair of bushings 320, one or both of which can be electrical insulators.

In systems that utilize a heater element configured to operate at a substantially constant temperature, the heating element may be PTC (positive thermal coefficient) elements. Such devices are configured to have a threshold temperature beyond which the electrical resistance of the device rises sharply, effectively shutting off current to the device when it reaches the selected operating temperature, without the need for sensors or controllers. As soon as water is injected into such a heater, vaporization of the water pulls the temperature of the device below the threshold, and the resistance drops, allowing current to pass and energize the heater.

Returning to FIG. 4, the throttle sub-system 500 is located immediately upstream from the injector/heater 300. In its simplest form, the throttle sub-system 500 incorporates a throttle body 502 and a throttle plate 504. The structure and function of the throttle body 502 and throttle plate 504 need not differ from those currently used in internal combustion engines. The intake manifold sub-system 600 is located immediately downstream of the injector/heater 300.

Manufactured Systems for Injecting Water into Intake Systems

FIG. 7 illustrates one alternate example of a water injection system. In the illustrated alternate, the air duct 306 is formed as a unit with the intake manifold 600 and/or the throttle body 502. As such, the entire assembly can be manufactured in one or two pieces, which can reduce the cost of installation and maintenance. Unlike the prior example, which is designed to be retrofit onto existing vehicles, the example of FIG. 7 is designed for original manufacture.

Systems For Injecting Water at or Near Intake Ports

FIG. 8 illustrates yet another alternate example of a water injection system. In the illustrated example, several injectors 304 and heaters 310 are used in combination with a multi-cylinder engine. As illustrated, the number of injectors 304 and heaters 310 corresponds with the number of cylinders; however, the ratio could change based on cost, space or other limitations.

The pressurized water from the pump is routed toward the engine and, en route, is divided into several separate lines. Each line contains a single injector 304 and a single heater 310. The heater 310 is then coupled to the intake manifold 600 in a manner that facilitates the passage of steam into the manifold at a location proximate the intake valve for the respective cylinder.

Because each injector 304 and each heater 310 is dedicated to a single cylinder-or perhaps two or more cylinders-the amount of water injected and heated at each heater is less than the amount of water heated by the heater described in the example described with reference to FIGS. 1-6. Further, because the respective injectors 304 and heaters 310 are timed based on the respective pistons, the heaters will not all be operating simultaneously. Thus, the amount of electricity drawn by the system at any given time is less than the amount of electricity drawn by the heater 310 in the first embodiment. The illustrated embodiment thus draws less electricity, per unit of time, than the first embodiment, and thus may allow the system to operate using a lower gauge alternator than other embodiments of the system.

Water Injection Control System

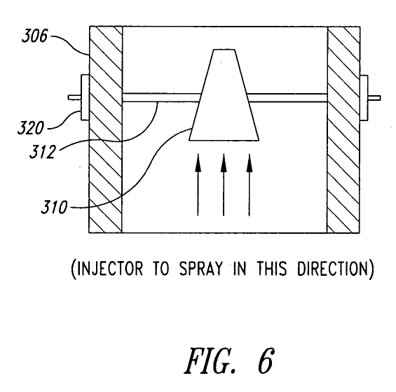

Referring now to FIG. 9, a controller 118 is shown in accordance with an embodiment of the invention. The controller 118 includes inputs from one or more of the following: a system monitor; a water pressure sensor; a fuel injector control signal; an intake air temperature sensor; an engine coolant temperature sensor; a power train control module signal (also sometimes referred to as an electronic control unit); an ignition signal; a throttle position sensor; a manifold absolute pressure sensor; an O₂ sensor; and a heater monitor. The controller 118 is further configured to provide one or more of the following control signals: a water heater control signal, configured to control the power input to the pre-heater 202 of FIG. 2, for example; O₂ sensor signal to the power train control module O₂ sensor input; heater element control, configured to provide a control signal to the heater element 310 of FIG. 6, for example; water injection pulse signal, configured to control operation of the valve 304 of FIG. 3, for example; and water pump signal, configured to control the operation of the pump 116 of FIG. 2, for example.

The interface module 118 of FIG. 9 may, according to particular requirements, be configured to receive any one or more of the previously listed input signals and process the data from those signals in order to provide one or more of the previously listed output signals to control the water injection system.

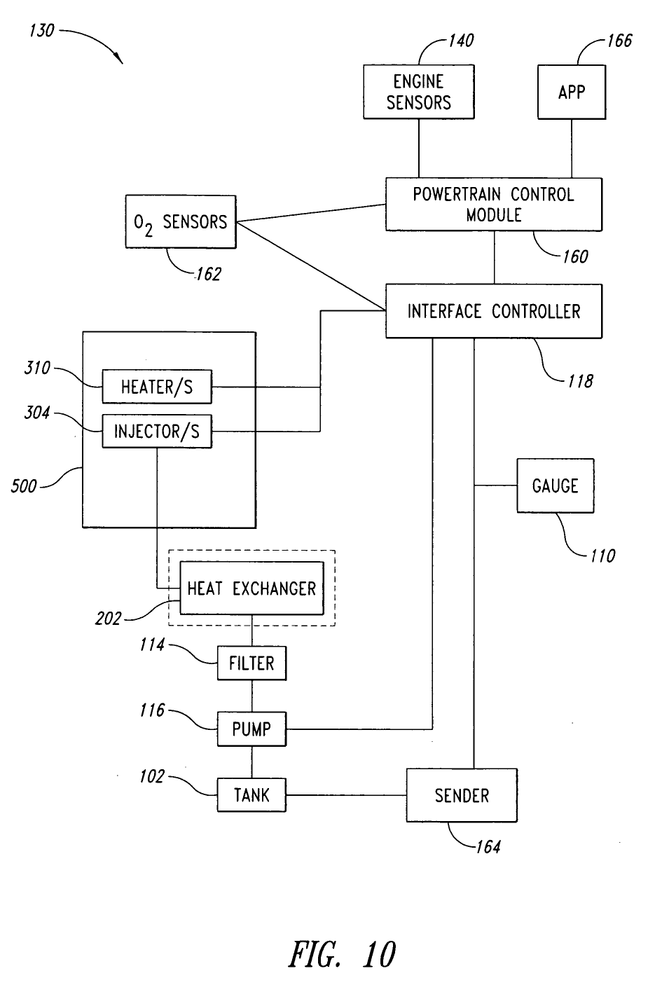

Referring now to FIG. 10, a control system according to an embodiment of the invention is diagrammatically outlined. A power train control module 160 receives input signals from O₂ sensors 162, a variety of engine sensors 140, as well as other typical inputs 166. In turn, a signal from the PCM 160 is provided to the interface controller 118, together with a signal from O₂ sensors 162 and water tank level sensor 164. The interface controller 118, based upon the input signals from the O₂ sensors 162 and the power train control module 160, provides a control signal to the water pump 116 in order to maintain appropriate pressure in the system, and to the heaters and injectors 310, 304 at the intake manifold 500, in order to provide an optimum volume of vaporized water to the intake manifold 500. The signal from the sender unit 164 provides a signal to the interface controller 118 such that, in the event the tank nears empty, the interface controller shuts down the water injection system 130 in order to prevent damage thereto. A gauge 110 is provided on the dashboard of the vehicle such that an operator can monitor the level of water in the tank 102.

Stock Sensor Input Control System

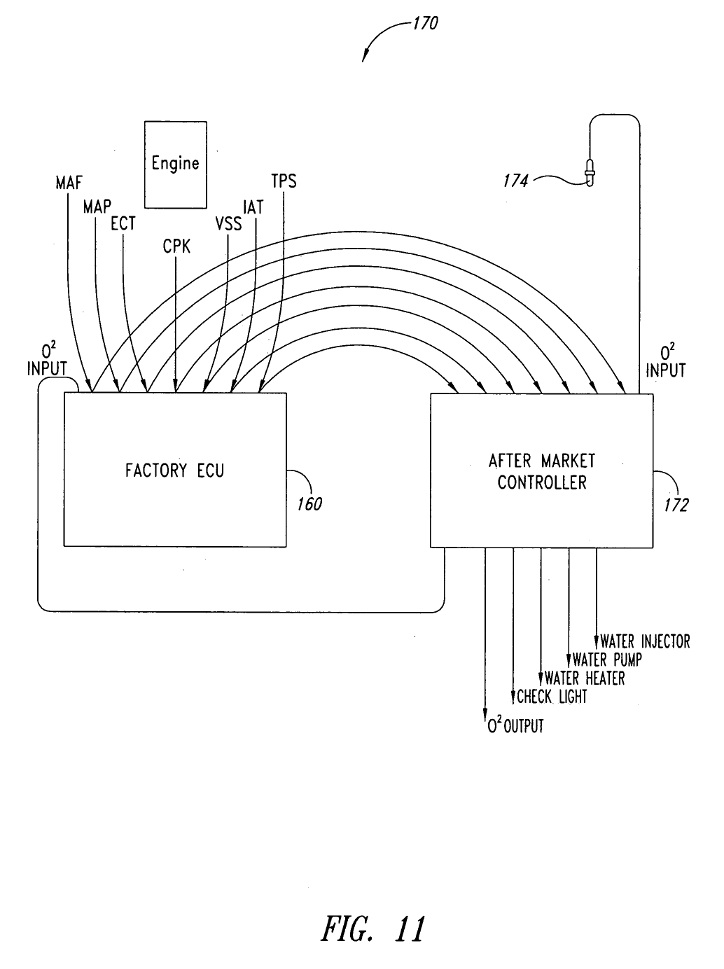

Water injection systems of various designs and configurations have been known in the industry for many years. The advantages of such systems are also well known. The injection systems described above with reference to FIGS. 1-8, as well as other water injection systems, can be installed in a vehicle as a retrofit improvement at reasonable expense. However, another expense that must be addressed is the cost of obtaining and installing sensors of various types for the purpose of providing data to a controller in order to afford optimum results from the system. FIG. 11 illustrates an injection control system 170 according to an additional embodiment of the invention. Typical modern vehicles are provided with power train control modules (PCM), or electronic control units (ECU) 160. Such modules receive inputs from various sensors, in order to monitor the operation of various sub-systems of the vehicle, including the following:
An oxygen (O₂) sensor provides a signal indicating the amount of oxygen in the exhaust gasses. The ECU is configured to adjust the air/fuel ratio according to the signal provided by the O₂ sensor.
An engine coolant temperature sensor (ECT) indicates the temperature of the coolant, from which the PCM infers the operating temperature of the engine. Information from this sensor is used to determine when the engine has warmed to a threshold temperature, beyond which the ECU switches to closed circuit operation. Until the switch to closed circuit operation, the O₂ sensor signal does not influence the air fuel mixture settings.
A mass air flow sensor (MAF) is provided to sense the amount of air drawn into an engine. The ECU 160 uses information from the MAF to calculate engine load. This is necessary to determine how much fuel to inject, when to ignite each cylinder, and when to shift the transmission.
A manifold absolute pressure sensor (MAP) is located within the intake manifold of an engine and provides a signal indicating the absolute pressure within the manifold. This information is used to determine the density of the air entering the combustion chamber, which in turn is used to calculate the proper air/fuel mixture for the engine.
A Crank shaft position sensor (CKP) indicates the position of the crank shaft of the engine. Information from this sensor is utilized to control the timing of fuel injection, cylinder ignition, and variable valve timing. Information from this sensor can also be used to determine rotation speed of the engine.
A Vehicle speed sensor (VSS) provides information to the speedometer as well as the vehicle ECU.
An intake air temperature sensor (IAT) provides a signal indicating the ambient temperature of the air as it enters the vehicle. This information is used to adjust the fuel-air mixture ratio.
A throttle position sensor (TPS) detects movement of the accelerator for the purpose of providing acceleration control of the vehicle.

The embodiment of FIG. 11 further includes an injection system controller 172 configured to receive an input from one or more of the signals discussed above, for the purpose of providing control signals to components of the water injection system.

For example, as is known in the industry, the optimum volume of water to be injected into an engine varies according to the load on the engine, which may be determined from the MAP signal and the TPS signal. Given a known load and a known engine rotation speed (from the CKP signal), an optimum injection flow rate can be determined. The controller 172 controls the flow rate by providing a signal to the water pump (116 of FIG. 2, for example) to control injector pressure, and a signal to the injector (308 of FIG. 4, for example) to control injector timing.

In systems that employ vaporized water, an optimum vaporization temperature is in a range sufficiently high that water remains in the vapor state until it is drawn into a cylinder, but not much higher, to avoid wasting energy by overheating the vapor. The absolute pressure in the intake manifold, provided by the MAP sensor, affects the temperature at which water is vaporized, and the temperature of the air, as indicated by the IAT sensor, affects the rate at which water vapor will recondense into water droplets. Given this information, together with the water flow rate, the controller 172 provides an appropriate power setting to the heat element (310 of, FIG. 4, for example) via a control signal to the element.

A typical vehicle ECU utilizes engine rpm, engine load, and O₂ in the exhaust gasses to calculate the optimum air/fuel ratio of an engine. The ECU establishes these values from the MAP, TPS, CKP and O₂ sensor signals. It is well known in the industry that an optimum air/fuel ratio of an engine operating without water injection can be different from that of an engine operating with a water injection system. According to an embodiment of the invention, the O₂ sensor 174 is disconnected from the ECU, and routed to the controller 172, instead. The controller 172 is configured to establish rpm and load as described previously, receive the signal from the O₂ sensor, and provide a modified O₂ sensor signal to the vehicle ECU such that, in responding according to its normal programming, the ECU actually controls the air/fuel mixture for optimal function with water injection operation.

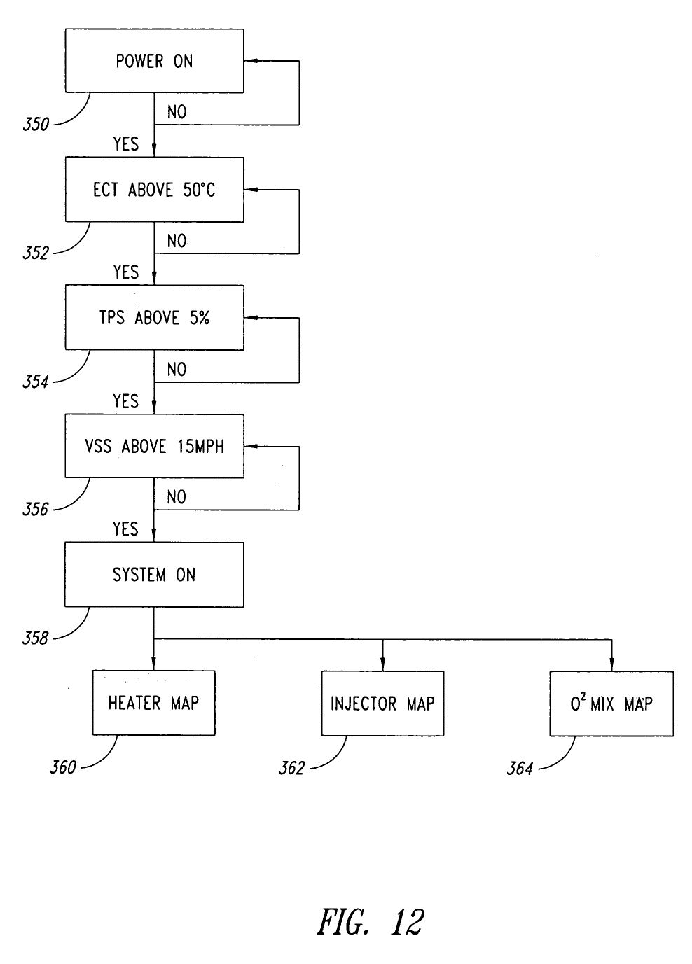

FIG. 12 shows a flow chart depicting the operation of a water injection control system such as that described with reference to FIG. 11. Upon power-up of the system (350), the coolant temperature is monitored (352). When engine temperature rises above 50 degrees, a minimum throttle position (354) and minimum vehicle speed (356) are established, and the injection system is activated. Upon activation, the controller provides control signals to control power to the heater (360), water injection flow rate (362), and O₂ sensor output (364), each as described above.

According to an embodiment of the invention, the water injection system controller 172 may also include inputs configured to receive any of a number of additional sensor signals, including those described hereafter:
A water level sensor signal, configured to indicate a water level within a tank from which is drawn water for the water injection system and utilized by the controller to provide an output signal configured to control a warning light or level gage for a vehicle operator, as well as for shutting down the water injection system, in the event the tank should run empty.
A water line pressure sensor signal, configured to indicate a pressure level in a water line downstream from a pump in the system such as the pump 116 of FIG. 2. This signal may be utilized by the controller to regulate the pressure of the water injection system.
An injection water temperature signal, configured to indicate the temperature of water at the injectors and utilized by the controller to determine the energy necessary to vaporize the water.
A manifold water residue sensor, configured to indicate the presence of water condensation within the intake manifold, and utilized by the controller to detect faults in the water injection system.
Intake air humidity sensor signal, configured to indicate a level of relative humidity in air entering the intake manifold, and utilized by the controller to adjust the volume of water being added to the intake manifold.
A supply voltage sensor signal configured to monitor the voltage level of an electrical power source powering the injector system, and utilized by the controller to detect excursions of the voltage beyond maximum or minimum thresholds, and to shut down the system in such events to prevent damage thereto.

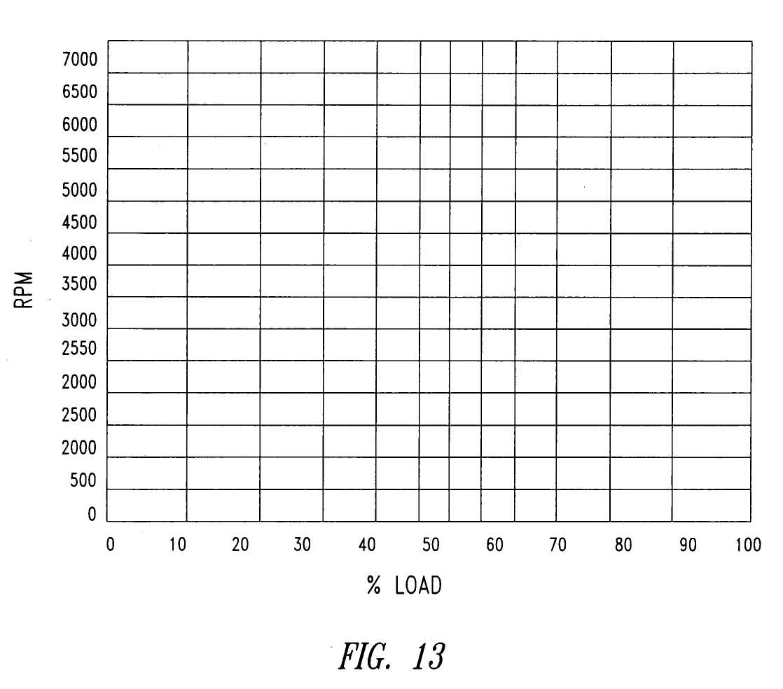

Referring now to FIG. 13, a chart is shown that illustrates a decision matrix in a case in which two operating parameters of an engine are obtained in order to generate a control signal output. For example, both water injection volume and O₂ sensor signal adjustment can be optimized, given engine rpm and engine load. Engine rotation speed, across a total range of 0-7000 rpms, is shown in the y-axis, and engine load, across a total range of 0-100%, is shown in the x-axis. These values can be established as described previously.

In the example illustrated in FIG. 13, the total ranges represented by the x and y-axes are each divided into a plurality of discreet ranges, resulting in a plurality of cells corresponding to the intersections of the range divisions in the x and y-axes. Each cell represents a particular instruction set, algorithm, or equation to be used in modifying one or more of the output signals of the associated controller. It may be seen that the y-axis is divided evenly across its total range. This does not suggest that an output signal is to be varied in a linear fashion, but rather that each row of cells represents a range of equal width. In the case of the example of FIG. 13, the width is 500 rpms. In contrast, the x-axis is divided in a nonlinear fashion such that the columns of cells at the extreme ends of the scale are substantially wider than the columns toward the center. The result of such an arrangement is that, even though the x-axis is divided into fewer discrete ranges than the y-axis, more of those ranges are concentrated in the portion of the total range within which the associated engine most commonly operates. Thus, the most commonly occupied operating ranges of the engine will correspond to the highest number of cells, permitting finer control of the system operating parameters within those ranges of operation that are most frequently occupied by the vehicle. In this manner, efficiency of operation can be maximized without the need for a larger number of memory locations.

In operation, a controller utilizing such a matrix first establishes the engine rpm and load from the available signal inputs, as described previously, then determines which row and column correspond to the established values, obtains the instruction or algorithm associated with the cell corresponding to the intersection of the row and column, and applies the resulting instruction or algorithm to modify or adjust the values of one or more of the output signals. In this manner the operation of the engine can be optimized across a wide range of operating conditions.

It will be recognized that the principles described with reference to two engine operating parameters as shown in FIG. 13 may be applied to systems configured to respond to three or more operating parameters.

Terms such as rows and columns are for convenience only, and may be considered interchangeable. Additionally, such terms may be used in reference to decision structures employing additional sets of variables such that the structures cannot be easily reduced to simple graphical representations.

The instructions, algorithms, or equations described with reference to each of the cells of FIG. 13 may be stored as data in a memory associated with the controller or may be represented by logic circuits, lookup tables, digital or analog process control circuitry, or any other appropriate structure. Such associated memory or circuitry may be integrated as part of the controller, or may be a separate device accessed by the controller.

As has been indicated, one of the advantages afforded by the embodiment described with reference to FIGS. 11-13 is that a water injection system can be controlled and operated in a highly effective manner without the need to add additional sensors to the vehicle, by utilizing inputs from sensors that are standard on the vehicle. Nevertheless, the scope of the invention is not limited to such sensors as would be regarded as standard equipment on a typical vehicle, but also encompasses devices using other sensor and signal inputs.

According to another embodiment of the invention, a system is provided in which the functions of the water injection system controller 172 are incorporated with a vehicle electronic control unit, into a single control unit. Such a device may be used as part of the factory installed standard equipment of a vehicle, and may be operated in conjunction with a factory installed water injection system. Alternatively, such a device may be provided as an after market control unit to be substituted in place of a standard unit.

Summary

Where used in the claims, the term circuit is used broadly to include software or firmware configured such that an associated device performs the functions described with reference to the circuit, integrated circuit devices, component circuit devices, electrical systems etc. Additionally, the claimed circuit may be part of another circuit, may be a separate circuit, or may comprise portions or all of separate devices.

As used in the claims, reference to water injection is used broadly to include the introduction of water in any form, including steam or atomized liquid, into the combustion train of an engine. Accordingly, unless otherwise specified, the term water injection is to be read on systems in which water is introduced into individual cylinders, air intake manifolds, fuel lines, and any other means for introducing water to be present during combustion.

Embodiments of the present invention can have many advantages over systems and methods of the prior art. For example, the present invention may allow improved control of engines incorporating water injection systems as compared to previously known methods, and retrofitting of conventional engines to receive water injection at a reduced cost, as compared to known methods of retrofitting. These and other advantages may be appreciated by practicing the present invention.

All of the U.S. patents, U.S. patent application publications, U.S. patent applications; foreign patents, foreign patent applications and non-patent publications referred to in this specification and/or listed in the Application Data Sheet, are incorporated herein by reference, in their entirety.

1. A device for controlling injection of water into an internal combustion engine, comprising:
a controller configured to receive a manifold absolute pressure sensor signal at a first input terminal and provide an engine water injection control signal at a first output terminal, the controller configured to modify the control signal in response to variations in the sensor signal.

2. The device of claim 1 wherein:
the first input terminal is one of a plurality of input terminals;
the controller is further configured to receive at least one of: a mass air flow sensor signal, a fuel injector signal, a throttle position sensor signal, an engine coolant temperature sensor signal, an intake air temperature sensor signal, a vehicle speed sensor signal, an engine rotation speed sensor signal, a water level sensor signal, a water line pressure sensor signal, an injection water temperature sensor signal, a manifold water residue sensor signal, and a supply voltage sensor signal at respective ones of the plurality of input terminals; and
the controller is further configured to modify the engine water injection control signal in response thereto.

3. The device of claim 2 further comprising a control matrix having a plurality of cells, each of the cells representing a range of signal levels from each of the plurality of input terminals, and wherein the controller is further configured to select a cell of the matrix representing ranges, from each of the plurality of input terminals, within which signal levels present at each of the plurality of input terminals fall, and to modify the engine water injection control signal in accordance with values associated with the selected cell.

4. The device of claim 3, comprising a memory module, and wherein the matrix resides in the memory module.

5. The device of claim 4 wherein the memory module is comprised by the controller.

6. The device of claim 3 wherein the possible range of signal levels of each of the plurality of inputs is divided into ranges of signal levels, each being represented by a row of cells of the control matrix.

7. The device of claim 6 wherein a selected portion of the possible range of signal levels of each of the plurality of inputs is evenly divided into the ranges of signal levels.

8. The device of claim 6 wherein the possible range of signal levels of each of the plurality of inputs is divided into the ranges of signal levels such that a width of each range varies according to a selected criterion.

9. The device of claim 8 wherein the selected criterion is operation time, such that the width of each of the ranges is inversely related to an anticipated percentage of the operation time of the device during which the value at the respective input terminal falls within the corresponding range.

10. The device of claim 1 wherein:
the first output terminal comprises one or more control output terminals;
the engine water injection control signal comprises one or more of: a water injector control signal, an injection water heater control signal, an injection water pump signal, and a check indicator signal; and
the controller is configured to provide each signal comprised in the engine water injection control signal at a respective one of the control output terminals.

11. The device of claim 1, further comprising an engine water injection system having a control input configured to receive the engine water injection control signal, and to inject atomized water into an inlet of an engine according to a value of the control signal.

12. The device of claim 1, further comprising an engine water injection system having a control input configured to receive the control signal and to inject vaporized water into an inlet of an engine according to a value of the control signal.

13. The device of claim 12 wherein the inlet is an intake manifold of the engine.

14. The device of claim 12 wherein the engine water injection system further comprises an injection-water heater configured to vaporize water prior to injection into the inlet.

15. The device of claim 1 wherein the controller is further configured to receive an oxygen sensor signal at a second input terminal.

16. The device of claim 15 wherein the controller is further configured to provide a modified oxygen sensor signal at a second output terminal.

17. The device of claim 16, further comprising a vehicle electronic control unit configured to receive the modified oxygen sensor signal and adjust fuel mixture of an engine accordingly.

18. The device of claim 15 further comprising a control matrix having a plurality of cells, each of the cells representing a range of signal levels from each of the first and second input terminals, and wherein the controller is further configured to select a cell of the matrix representing ranges, from each of the first and second input terminals, within which signal levels present at each of the first and second input terminals fall, and to modify the engine water injection control signal in accordance with values associated with the selected cell.

19. The device of claim 18 wherein the controller is configured to modify the values associated with one or more of the plurality of cells in response to the oxygen sensor signal.

20. The device of claim 1, further comprising a vehicle electronic control unit, and wherein the controller is comprised by the vehicle electronic control unit.

21. A device for controlling injection of water into an internal combustion engine, comprising:
a first terminal configured to receive a first signal from an oxygen sensor of the engine;
a second terminal configured to supply a second signal to an oxygen sensor input terminal of a power train control unit associated with the engine; and
a circuit configured to receive the first signal from the first terminal, modify the first signal to produce the second signal, and supply the second signal to the second terminal, the modification of the first signal being such that control of the internal combustion engine by the power train control unit is optimized for operation of the engine with a water injection system.

22. The device of claim 21, comprising a third terminal configured to supply a third signal for controlling the water injection system, and wherein the circuit is configured to modify the third signal in response to changes in the first signal.

23. The device of claim 21 wherein the device is configured to receive at respective additional terminals, at least one of: a manifold absolute pressure sensor signal, a mass air flow sensor signal, a fuel injector signal, a throttle position sensor signal, an engine coolant temperature sensor signal, an intake air temperature sensor signal, a vehicle speed sensor signal, an engine rotation speed sensor signal, a water level sensor signal, a water line pressure sensor signal, an injection water temperature sensor signal, a manifold water residue sensor signal, and a supply voltage sensor signal.

24. The device of claim 21 wherein the circuit is configured to modify the first signal and control operation of a water injection system at least in part in response to engine rpm and engine load.

25. A system comprising:
an internal combustion engine;
a plurality of sensors, each configured to monitor a respective aspect of operation of the engine and provide a corresponding sensor signal, the plurality of sensors including at least one of: a manifold absolute pressure sensor, a mass air flow sensor, a fuel injector, a throttle position sensor, an engine coolant temperature sensor, an intake air temperature sensor, a vehicle speed sensor, an engine rotation speed sensor, a water level sensor, a water line pressure sensor, an injection water temperature sensor, a manifold water residue sensor, a supply voltage sensor, and an oxygen sensor;
a power train control unit configured to receive the respective sensor signal from each of the plurality of sensors and control at least some operational aspects of the engine in response to the signals provided;
a water injection system configured to inject water into a combustion system of the internal combustion engine; and
a water injection system control unit configured to control operation of the water injection system in response to the signals provided to the power train control unit.

26. The system of claim 25 wherein the power train control unit and the water injection system control unit are integrated into a single control unit.

27. The system of claim 25 wherein the power train control unit and the water injection system control unit are separate units, and wherein the sensor signal from the oxygen sensor is received by the water injection system control unit and the water injection system control unit provides a modified oxygen sensor signal to the power train control unit.

28. A method, comprising:
Receiving a first signal from an oxygen sensor of an internal combustion engine;
providing a second signal to an oxygen sensor signal input of a power train control unit configured to control operation of the engine,
producing the second signal by modifying the first signal such that, in responding to the second signal, the power train control unit controls operation of the engine to improve aspects of the engine's performance in conjunction with a water injection system, as compared to engine performance in response to the first signal.

29. The method of claim 28, further comprising:
receiving signals from sensors that also provide signals to the power train control unit; and
controlling operation of the water injection system at least partially in response to the signals received from the sensors.
